(19) United States
(12) Patent Application Publication
(10) Pub. No.: US 2002/0118161 A1
(43) Pub. Date: Aug. 29, 2002

(54) Correction method for auto brightness control light sensors in liquid crystal displays

(76) Inventor: Chia-Yang Lin, Kuei-Shan Hsian (TW)

Correspondence Address: RABIN & CHAMPAGNE, PC, 1101 14TH STREET, NW, SUITE 500, WASHINGTON, DC, 20005, US

(21) Appl. No.: 09/791,630

(22) Filed: Feb. 26, 2001

(51) Int. Cl. G09G 3/36

(52) U.S. Cl. 345/102

(57) ABSTRACT

A correction method for auto brightness control light sensors in liquid crystal displays (LCDs). The disclosed method contains at least the following steps: Establish a correspondence range table of environmental brightness and LCD panel brightness. The light sensor generates an input voltage signal. The input voltage signal is output to a voltage control oscillator, which then outputs an output frequency. A correspondence range is then provided and the maximum, mean value and minimum are set. Finally, the output frequency is output to a microprocessor according to the correspondence range table. A control signal is output to correct the brightness of the back-light panel of the LCD.

### BACKGROUND OF THE INVENTION

1. Field of Invention

The present invention relates to a correction method for an auto brightness control light sensor and, more particularly, to a correction method for auto brightness control light sensors used in liquid crystal displays.

2. Related Art

Using a CDS as a light sensor to control the back-light brightness of a liquid crystal display (LCD) can greatly lower the hardware cost. However, the CDS has a big error in its resistance value so that the output value of the light sensors will differ very much due to different CDSs when operating in the auto mode. In fact, the difference does not result in erratic actions of the light sensing circuit. It is the output range which differs for different CDSs. Therefore, it becomes the trouble for mass production. Very often one does not know whether the sensor output is within an acceptable range, thus wasting a lot of time in multiple circuit checks and even influencing the quality and progress in product manufacturing.

In the prior art, a CDS 100 is used as a light sensor to control the back-light brightness of a liquid crystal display (LCD). As shown in FIG. 1, the conversion of the environmental brightness into digital data is achieved through an analogue/digital converter (ADC) 110. That either a microprocessor 120 is or is not contained in the ADC 110 will cost a lot. If a sensor board 130 and the microprocessor 120 are separately designed, there needs at least eight transmission lines 140 to connect signal lines.

Another cost-saving technology also uses the CDS 200 as a light sensor to control the back lit brightness of an LCD. As shown in FIG. 2, a voltage-controlled oscillator (VCO) 210 is used to convert the environmental brightness into some frequency, which is then sent to a microprocessor 220 to calculate its frequency cycle that reveals the information about brightness changes. If a sensor board 230 and the microprocessor 220 are separately designed, only one data line 240 is needed. This design does not only cost little but is also featured in that its components are more accessible. The price of the VCO 210 is only about one tenth of that of the ADC 100.

However, purely using the ADC 110 or the VCO 210 as the auto brightness control device for LCDs still cannot have different output range settings according to the characters of different light sensors. Therefore, they cannot strengthen the stability of circuits unless the circuit designs are modified. This, nevertheless, is very expensive and ineffective.

### SUMMARY OF THE INVENTION

The invention utilizes a software correction procedure to provide a correction method for auto brightness control light sensors in liquid crystal displays (LCDs). It is an objective to solve the problem of LCD auto brightness control failure due to different error ranges in different light sensors.

The disclosed method contains at least the following steps: Establish a correspondence range table of an environment brightness and LCD panel brightness. The light sensor generates an input voltage signal. The input voltage signal is output to a voltage control oscillator, which then outputs an output frequency. A correspondence range is then provided and the maximum, mean value and minimum are set. Finally, the output frequency is output to a microprocessor according to the correspondence range table. A control signal is output to correct the brightness of the back-light panel of the LCD.

### BRIEF DESCRIPTION OF THE DRAWINGS

The present invention will become more fully understood from the detailed description given hereinbelow illustration only, and thus are not limitative of the present invention, and wherein:

FIG. 1 shows a schematic circuit of an LCD auto brightness control using the ADC in the prior art;

FIG. 2 shows a schematic circuit of an LCD auto brightness control using the VCO in the prior art;

FIG. 3 shows a schematic circuit of an LCD auto brightness control using the VCO according to the invention;

FIG. 4 shows the relation between the input voltage and the output frequency when using the VCO as the LCD auto brightness control according to the invention; and

FIG. 5 illustrates a flowchart of the correction method for auto brightness control light sensors in LCDs.

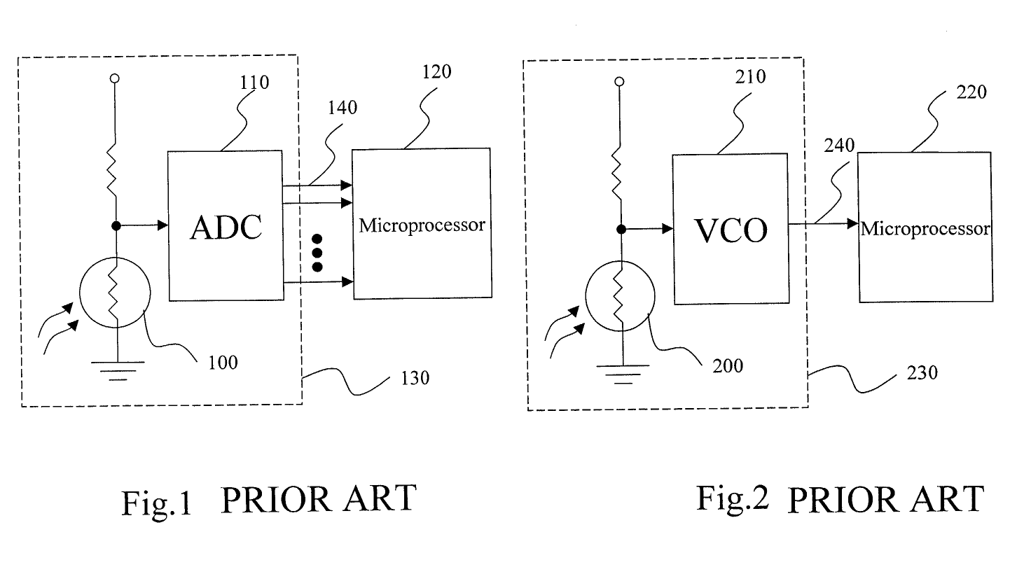

### DETAILED DESCRIPTION OF THE INVENTION

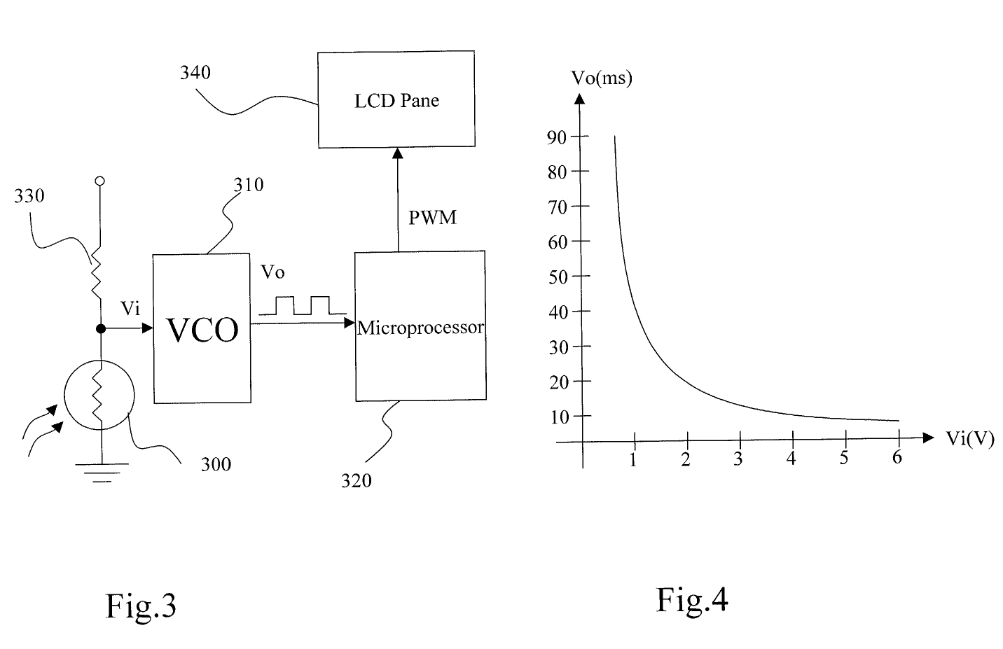

The invention provides a correction method for auto brightness control light sensors in liquid crystal displays (LCDs). It mainly helps the auto brightness control light sensor of the LCD correcting its output. Through the control of a microprocessor, the correct auto brightness control of the LCD can be achieved. With reference to FIG. 3, a CDS 300 is used as a light sensor to control the back-light brightness of the LCD 340. A voltage-controlled oscillator (VCO) 310 is used to convert the environmental brightness into some frequency, which is then sent to the microprocessor 320 to calculate its frequency cycle. The microprocessor 320 outputs a pulse width modulation (PWM) to control the brightness of a back-light panel of the LCD 340. The signal entering the VCO 310 makes the CDS 300 generate different input voltages Vi according to different resistance values through the design of a partial voltage resistor 330 at a receiver terminal. The CDS 300 further outputs the corresponding output frequency Vo according to the VCO 310.

From FIG. 4, one can know that the input voltage is inversely proportional to the output frequency. From this relation, one can establish a correspondence table covering a great range so as to tolerate the intrinsic errors of the CDS 300. A software correction procedure is employed to satisfy the need for controlling the brightness of the LCD back-light panel using the microprocessor.

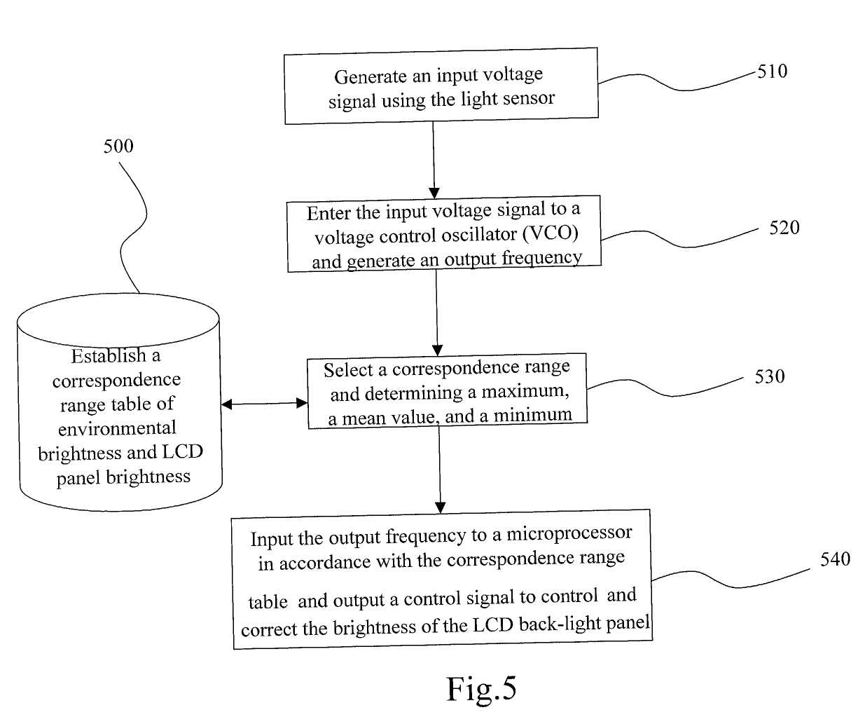

With reference to FIG. 5, the disclosed method starts by establishing a correspondence range table for the environmental brightness and the LCD panel brightness (step 500). The brightness range can be set into several setting values (a plurality of levels). Taking the invention as an example, the first level is set into 0 through 31, totally 32 setting values, with 800 LUX brightness defined to automatically correspond to 31 and 350 LUX to 0. At the second level, the brightness range is set to between 0 and 31, totally 32 setting values, with 750 LUX brightness defined to automatically correspond to 31 and 300 LUX to 0. Other levels are defined in a similar fashion. After defining the correspondence range of the environmental brightness (step 500), the method enters a factory correction procedure. A light sensor is used to generate an input voltage signal (step 510). The input voltage signal is output to a VCO and an output frequency is generated (step 520). The method then enters a light sensor correction procedure for LCD auto brightness control. A correspondence range is provided for selection and the maximum, mean value and minimum are set (step 530). After the parameters are set, the output frequency is output to a microprocessor in accordance with the correspondence range table. A control signal is output to control and correct the brightness of the LCD back-light panel (step 540). The invention uses a VCO 310 as a device to convert the environmental brightness. The control signal output from the microprocessor is a pulse width modulation (PWM). Using a conventional ADC as the device that converts the environmental brightness is not only able to correct the intrinsic error of the CDS but also able to achieve accurate corrections.

The disclosed method further comprises a normal value setting so that the maximum>the mean value>the minimum and when the output frequency range of a light sensor is too small, a warning or error message is displayed.

Certain variations would be apparent to those skilled in the art, which variations are considered within the spirit and scope of the claimed invention.

What is claimed is:

1. A correction method for auto brightness control light sensors of liquid crystal displays (LCDs), which comprises the steps of:
establishing a correspondence range table of environmental brightness and LCD panel brightness;
generating an input voltage signal using the light sensor;
entering the input voltage signal to a voltage control oscillator (VCO) and generating an output frequency;
selecting a correspondence range and determining a maximum, a mean value, and a minimum; and
inputting the output frequency to a microprocessor in accordance with the correspondence range table and outputting a control signal to control and correct the brightness of the LCD back-light panel.

2. The method of claim 1, wherein the light sensor is a CDS.

3. The method of claim 1, wherein the correspondence range table contains a correspondence range defined by the environmental brightness.

4. The method of claim 1, wherein the correspondence range can be set to have a plurality of setting values.

5. The method of claim 1 further comprising the step of a normal value setting so that the maximum>the mean value>the minimum.

6. The method of claim 1 further comprising the step of displaying a warning or error message when the light sensor output frequency range is too small.

7. The method of claim 1, wherein the VCO can be replaced by an analogue/digital converter (ADC).
